(19) United States
(12) Patent Application Publication
(10) Pub. No.: US 2012/0030014 A1
(43) Pub. Date: Feb. 2, 2012

(54) Automatic Ad Creative Generation

(75) Inventors: Lawrence J. Brunsman, Mountain View, CA (US); Sriram Rajaraman, San Jose, CA (US); Priyendra Deshwal, Mountain View, CA (US); Matthew D. Wytock, San Jose, CA (US); Sheridan Kates, San Francisco, CA (US)

(73) Assignee: GOOGLE, INC., Mountain View, CA (US)

(21) Appl. No.: 12/846,315

(22) Filed: Jul. 29, 2010

(51) Int. Cl. G06Q 30/00

(52) U.S. Cl. 705/14.49

(57) ABSTRACT

Methods, systems, and apparatus, including computer programs encoded on computer storage media, that are operable to identify a web page that is to be a basis for an advertisement creative; extract content to create an advertisement for serving in response to a request, extracting including extracting a title for the web page; create a title for the advertisement creative including computing a snippet of the title based on the request and the extracted title; combine a body with the advertising creative title; and combine with the body a uniform resource locator (URL) for a landing page that is to be associated with the advertisement creative.

### BACKGROUND

This specification relates to providing information relevant to user requests.

Internet search engines identify resources, e.g., Web pages, images, text documents, and multimedia content, in response to queries submitted by users and present information about the resources in a manner that is useful to the users.

A conventional query processing service can include an input control that allows the user to provide a textual input in the form of a search query. In some conventional services, advertisements (ads) or other content can be provided to a user system for presentation in response to a received textual input provided by the user. In some instances, advertisements can be identified based on matches between textual input provided by a user and keywords associated with one or more advertisements.

Publishers can include content provided by third party content providers in publications under the publisher's control. At the time for publication (e.g., rendering), a request can be made to the third party content provider to supply the additional content. For example, an on-line newspaper publisher can include one or more advertisements with their publication. Each advertisement (ad) includes a creative that is typically provided by the advertiser. As another example, a web site includes advertisement slots in one or more web pages of the web site. The advertisement slots may be purchased by advertisers, and an advertisement server system provides the advertisements for display on behalf of the advertisers.

### SUMMARY

This specification describes methods, systems, and apparatus including computer program products for presenting content in response to a user request.

In general, one aspect of the subject matter described in this specification can be embodied in computer-implemented methods that include identifying a web page that is to be a basis for an advertisement creative; extracting content to create an advertisement for serving in response to a request, extracting including extracting a title for the web page; creating a title for the advertisement creative including computing a snippet of the title based on the request and the extracted title; combining a body with the advertising creative title; and combining with the body a uniform resource locator (URL) for a landing page that is to be associated with the advertisement creative.

These and other embodiments can each optionally include one or more of the following features. The request can be a query. The request can be a request for one or more advertisements to be published along with other content on a serving page. The body can include two lines and be based on content on the web page. The body can include two lines and be generic and not specifically related to the web page. Extracting the title can include identifying text that is in a larger font than other text in the web page. Extracting the title can include identifying anchors associated with the web page. Extracting the title can include identifying bi-grams and/or other n-grams in the title.

Extracting the title can include identifying the title of the web page; identifying and stripping non-essential material from within the title to create a stripped title; and segmenting the stripped title into known compounds to create an extracted title. Creating the title for the advertisement creative can include computing the intersection between the request and the extracted title. Creating the title for the advertisement creative can include generating all possible title snippets using a number of algorithmic rules; scoring the title snippets; and selecting a best snippet from the scored snippets for use as the advertisement creative title. Combining a body can include combining a best title with generic text. Combining a URL can include combining a URL for an advertiser associated with the web page and a link to a specific page to the body.

In general, another aspect of the subject matter described in this specification can be embodied in computer-implemented methods that include identifying a content item from a content source that is to be a basis for an advertisement creative; extracting content from the content item to create an advertisement for serving in response to a request, extracting including extracting one or more of a title, header or emphasized content from the content item; creating an advertisement creative title for the advertisement creative based on the request and the extracted content; combining a body with the advertising creative title; and combining with the body a uniform resource locator (URL) for a landing page that is to be associated with the advertisement creative.

These and other embodiments can each optionally include one or more of the following features. The request can be a query. The request can be a request for one or more advertisements to be published along with other content on a serving page. The body can include two lines and can be based on content included in the content item. The body can include two lines and can be generic and not specifically related to the content item. Extracting the title can include identifying text that can be in a larger font than other text in the content item. Extracting the title can include identifying anchors associated with the content item. Extracting the title can include identifying bi-grams and/or other n-grams in the title.

Extracting the title can include identifying the title of the content item; identifying and stripping non-essential material from within the title to create a stripped title; and segmenting the stripped title into known compounds to create an extracted title. Creating the title for the advertisement creative can include computing the intersection between the request and the extracted title. Creating the title for the advertisement creative can include generating all possible title snippets using a number of algorithmic rules; scoring the title snippets; and selecting a best snippet from the scored snippets for use as the advertisement creative title. Combining a body can include combining a best title with generic text. Combining a URL can include combining a URL for an advertiser associated with the content item and a link to a specific page to the body.

Particular embodiments of the subject matter described in this specification can be implemented so as to realize none, one or more of the following advantages. Portions of web pages that are relevant to the automatic generation of ad creatives can be identified. Web pages can be analyzed to identify titles within the web pages. Generic portions of web page titles can be removed from the web page titles. N-grams can be identified within web page content. Ad creatives can be automatically generated from information derived from web pages. Ad creatives and ad creative titles can be ranked to identify the highest ranked ad creatives or ad creative titles. Advertisements can be provided for a web page without the need for an advertiser to provide an ad creative for the web page. Highly relevant ad creatives can be automatically generated and identified. Ad creatives that are specific to individual queries can be automatically generated. Ad creatives can be displayed along side search results or other content requested by an end user without matching a user query or other ad request to keywords provided by an advertiser.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example system for generating an advertisement creative using information extracted from a web page.

FIG. 2 illustrates an example commercial landing page and an example advertisement creative generated from the commercial landing page.

FIG. 3 illustrates an example architecture for a query processing service system.

FIG. 4 illustrates an example method for generating an advertisement creative using information extracted from a web page.

FIG. 5 illustrates an example hardware configuration.

Like reference numbers and designations in the various drawings indicate like elements.

### DETAILED DESCRIPTION

The following disclosure describes systems, methods, and apparatus for providing advertisements derived from web pages (e.g., commercial landing pages) where the sponsor of the web page is not required to provide one or more of keywords and/or creatives. The advertisements derived from web pages can be served in response to a user submitted query and be displayed alongside search results for the user submitted query. Alternatively, the advertisements can be provided in response to a request for advertisements and published along with other content of a publisher. In some implementations, the web pages comprise commercial landing pages that provide information on purchasable products or services, or web pages that facilitate the purchasing of products or services. For example, a commercial landing page can be a page describing a particular brand of car polish. As another example, a commercial landing page can be a web page that allows a user to purchase a particular style of dress.

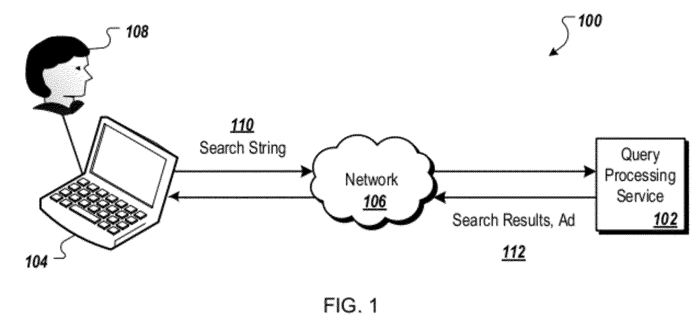

FIG. 1 illustrates an example system 100 for determining and providing query results and/or associated content in response to user input. The associated content can be of the form of Web content and/or Web-based advertisements (or “ads”) that are associated with the query. Non-ad Web content can include links to web sites or other content, news, weather, images, video, auctions, related information, answers to questions, or other information. The identification of associated ad content is described in greater detail below.

The system 100 includes a query processing service 102 that is communicatively coupled to a client device 104 via a network 106. The query processing service 102 can be any content provider or search engine provider, such as Google Search, that provides content and/or ads in response to user queries, inputs or other selections. Other forms of service are possible. The query processing service 102 can be accessible from applications running on the client device 104, such as coupled to (or in communication with) the user's Web browser, any search input dialog, and so forth. The information returned by the query processing service 102 can include search results for a user entered search query, and content (e.g., advertisements) that may correspond to the search results. In some implementations, the system 100 can be used to provide search results and ad content in response to input that the user has provided in applications other than Web browsers, such as input boxes or other controls used in support of other applications (e.g., forms used in online shopping applications). In some implementations, the system 100 can be used to provide relevant ads in response to processing a query that is of the form of an ad request.

In some implementations, system 100 receives user input, typically in a control (e.g., a search query box) that is presented on a user interface associated with the client device 104. The control can be of the form of a textual input box or other input mechanism that is configured to receive user input. In some implementations, the user input is of the form of textual characters, tokens or other input that make up a request. The user input can include numbers, letters, symbols, or other identifiers. The request can be of the form of a search query. The client device 104 can provide the user input, by way of the network 106, to the query processing service 102. In return, in some implementations, the query processing service 102 can provide search results along with other content back to the client device 104. While the system shown includes a remote query processing service 102 that is linked by way of the network 106, portions of the query processing service 102 can be included in the client device 104. While the system is described with reference to a query processing service, other forms of user requests and other services can be provided in support of a given user input.

In some implementations, additional content that is provided by the query processing service 102 along with search results includes one or more ads for presentation (e.g., along with the search results or with other publisher content). The ads provided by the query processing service 102 can link to web pages associated with one or more advertisers. In some implementations, the web pages are commercial landing pages. The commercial landing pages can be web pages that provide information on purchasable products or services offered by advertisers, or web pages that facilitate the purchasing of products or services offered by advertisers. In some implementations, one or more of the ads provided by the query processing service 102 are associated with keywords. The ads can be identified as being relevant to a user entered query based on matches between the query and the keywords associated with the ads. The keywords can be provided by the advertiser or developed by the query processing service 102 as described in greater detail below.

In some implementations, one or more of the ads provided by the query processing service 102 are not associated with keywords that have been provided by a respective advertiser. For example, a particular advertiser may not possess the resources to provide keywords in association with ads or commercial landing pages. In some implementations, prior search queries that were resolved to a given commercial landing page can be used along with one or more terms in a received query to identify commercial landing pages that are relevant to the received query. In some implementations, ad creatives can be automatically generated based on information extracted from the commercial landing pages. The automatically generated creatives can then be provided by the query processing service 102 in response to user entered queries.

In an example scenario of the system 100, the user 108 can enter a search string 110 using an input device of the client device 104. The client device 104 transmits the search string 110 to the query processing service 102 through the network 106. The query processing service 102 uses the received search string 110 to identify one or more commercial landing pages that are relevant to the search string 110. In some implementations, the query processing service 102 can identify relevant commercial landing pages by performing a search of commercial landing pages associated with advertisers that have contracted with the query processing service 102 to provide ads in association with commercial landing pages on behalf of the advertisers. For example, a number of advertisers can identify web sites or web pages for which advertisements are to be supplied by the query processing service 102 without providing keywords for the commercial landing pages. The query processing service 102 can identify commercial landing pages included in the indicated web sites and web pages. In some implementations, an advertiser can indicate a web site that includes commercial landing pages for which ads are to be supplied, and further indicate web pages included within the web site for which ads are not to be supplied. For example, one or more web pages included in a web site may not include any information for purchasable products or services.

The query processing service 102 can perform a search of the identified commercial landing pages to determine if the search string 110 is relevant to any of the commercial landing pages. The query processing service 102 can provide search results 112 for the search string 110 along with ads associated with the identified commercial landing pages to the client device 104 for presentation to the user 108. In some implementations, the query processing service 102 can generate the provided ads using information extracted from the commercial landing pages. For example, the query processing service 102 can extract a title or header from a commercial landing page and derive text for an ad from the extracted title or header. The query processing service 102 can additionally extract one or more images or logos from the commercial landing page to include in the provided ad. In some implementations, the provided ad includes a link back to the commercial landing page.

In some implementations, the query processing service 102 can access a database in order to match the search string 110 to one or more commercial landing pages. For example, prior to receiving the search string 110, the query processing service 102 can track previously received search queries and commercial landing pages that the search quires resolved to in order to create a database using queries previously resolved to the commercial landing pages. In some implementations, each query that is received by the query processing service 102 that resolves to at least one commercial landing page associated with an advertiser for which the query processing service 102 provides ads can be stored in the database. Each query stored in the database can point to the one or more commercial landing pages to which the query resolves. For example, each query/commercial landing page pair can be stored as a unique entry in the database.

In some implementations in which queries are associated with commercial landing pages in a database, upon receiving the search string 110 the query processing service 102 can access the database to determine if the search string 110 matches a query stored in the database. If the search string 110 matches a query stored in the database, the query processing service 102 can identify one or more commercial landing pages associated with the query within the database. The query processing service 102 can then provide one or more ads generated from content extracted from the commercial landing pages to the client device 104 along with search results 112.

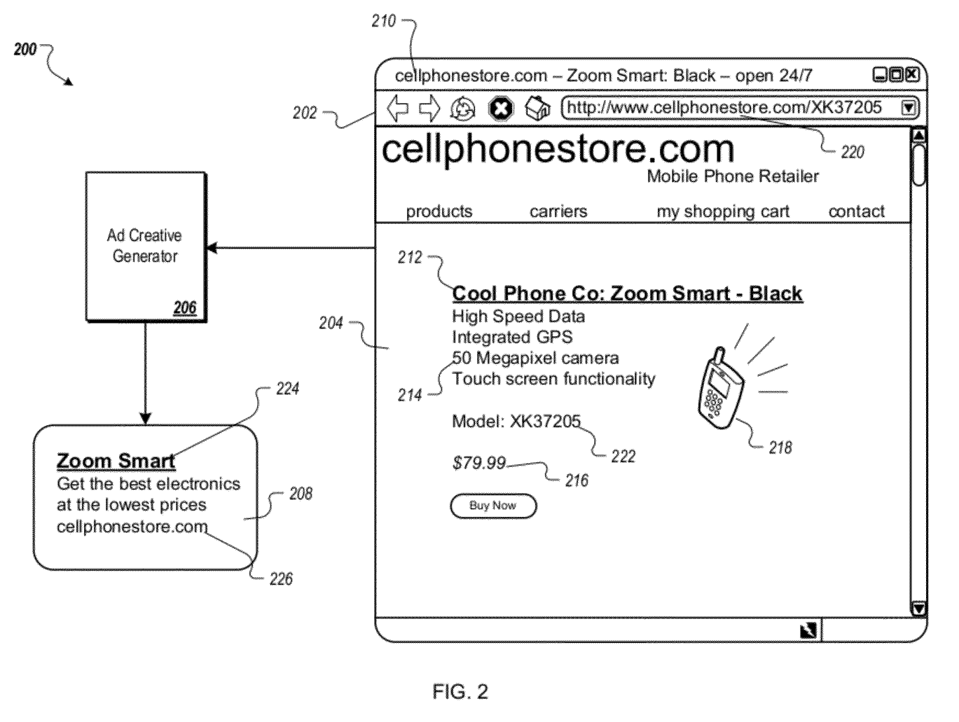

Referring now to FIG. 2, a system 200 includes an application (e.g., a browser 202) displaying a web page 204. The browser 202 can be displayed on a display screen (e.g., an LCD monitor) attached to or in communication with an end user device, such as the client device 104 of FIG. 1. An ad creative generator 206 can extract content from the web page 204 to generate an ad creative 208. The ad creative generator 206 can identify content extracted from the web page 204 for use in generating the ad creative 208 and other ad creatives.

In some implementations, the ad creative generator 206 can identify a title 210 for the web page 204 as potentially useful for generating an ad creative. In some implementations, the ad creative generator 206 can identify the title 210 by analyzing code used to render the web page 204. For example, the title 210 can be indicated as a title by title tags within HTML code used to render the web page 204. In some implementations, the ad creative generator 206 can identify generic (i.e., boilerplate) portions of the title 210 in order to generate a stripped title for the web page 204. For example, title 210 shown in FIG. 2 is “cellphonestore.com—Zoom Smart: Black—Open 24/7.” The ad creative generator 206 can identify the character strings “cellphonestore.com—” and “—Open 24/7” as generic portions of the title 210. The ad creative generator 206 can remove these character strings from the title 210 to obtain a stripped title for the web page 204.

In some implementations, the ad creative generator 206 can identify generic portions of a web page title using other sources of information. For example, the ad creative generator 206 can access other web pages included in the “cellphonestore.com” web site. The ad creative generator 206 can identify that the character strings “cellphonestore.com—” and “—Open 24/7” are included in a large number of web pages included in the cellphonestore.com web site. The ad creative generator 206 can use this information to determine that the two character strings are generic character strings and should be stripped when creating a stripped title for the web page 204.

In some implementations, the ad creative generator 206 can identify a header 212 displayed on the web page 204 as potentially useful for generating an ad creative. In some implementations, the ad creative generator 206 can identify the header 212 by analyzing code used to render the web page 204. For example, the header 212 can be indicated as a header by header tags within HTML code used to render the web page 204. In some implementations, the ad creative generator 206 can compare font and other format characteristics of the text of the header 212 to other text included in the web page 204 in order to identify the header 212 as important text. For example, as depicted in FIG. 2, the header 212 is displayed in a larger font than body text 214 included in the web page 204. The ad creative generator 206 can identify the header 212 as being important text since the text of the header 212 is larger than the body text 214 of the web page 204. The ad creative generator 206 can therefore identify the header 212 as a potential header for the web page 204.

In some implementations, the ad creative generator 206 can identify emphasized (e.g., bolded, underlined, or bolded and underlined) text as being a potential header for the web page. For example, as depicted in FIG. 2, the header 212 is bolded and underlined, whereas the body text 214 is not bolded or underlined. The ad creative generator 206 can use this information to identify the header 212 as a header. Other text attributes that can be used to identify a header or important text within a web page can include other forms of emphasis including italics, specialized coloring, position within the web page (e.g., near the top, near the center, etc.), or a special font (e.g., compared to other text of the web page). In some implementations, the header 212 can include generic (e.g., boilerplate) text that can be stripped by the ad creative generator 206 as described above for the title 210. For example, if the header is “Zoom Smart—Black (24 Hour Shipping)” the portion of the header that reads “(24 Hour Shipping)” can be stripped from the header to produce a stripped header.

In some implementations, the ad creative generator 206 can identify pricing information included in the web page 204 as potentially useful for generating an ad creative. For example, the ad creative generator 206 can identify the price 216 as a price for the cell phone described in the web page 204. The ad creative generator 206 can, for example, identify the “$” symbol in order to identify the price 216 as a price for the cell phone. The ad creative generator 206 can extract the price 216 from the web page 204 for use in generating an ad creative.

In some implementations, the ad creative generator 206 can identify additional text included in the web page 204 as potentially useful for generating an ad creative. For example, the ad creative generator 206 can compare the body text 214 to a received query or received keywords associated with an ad request. The received query can be, for example, a user entered search query. The received keywords can be, for example, keywords associated with advertisement slots for web pages. The ad creative generator 206 can compare a query or keywords to the body text 214 to identify portions of the body text 214 that can be useful for generating an ad creative. For example, if a user enters a query of “Cell Phone with GPS,” the ad creative generator 206 can identify the text “Integrated GPS” within the body text 214 as being potentially useful for generating an ad creative.

In some implementations, the ad creative generator 206 can identify one or more images or logos included in the web page 204 for use in generating an ad creative. For example, an image 218 can be identified as useful for generating an ad creative. In some implementations, the ad creative generator 206 can identify relevant images based on location within the web page 204. For example, a prominently located image can be identified as more relevant than other images. In some implementations, the ad creative generator 206 can identify relevant images based on uniqueness of the image to the web page 204. For example, an image that appears on only the web page 204 within a web site that includes the web page 204 can be identified as relevant to a product being described by the web page 204 and therefore useful for generating an ad creative. As another example, an image that appears on many web pages within the web site that includes the web page 204 can be identified as a generic or other less relevant image.

In some implementations, the ad creative generator 206 can identify a URL for the web page 204 as useful in generating an ad creative. For example, the ad creative generator 206 identifies a URL 220 for use in generating an ad creative. In some implementations, instead of or in addition to identifying the URL 220 for the web page 204, the ad creative generator 206 can identify a URL for a front page of a web site that includes the web page 204 for use in generating an ad creative. For example, for the URL 220 of “www.cellphonestore.com/XK37205” the ad creative generator 206 can additionally identify a web site URL of “www.cellphonestore.com” or “cellphonestore.com.”

In some implementations, the ad creative generator 206 can identify anchor text for the web page 204 as potentially useful for generating an ad creative. In some implementations, an anchor is text associated with a hyperlink that links to a destination web page. For example, a link on a second web page can link to the web page 204. Anchor text for the link on the second web page that links to the web page 204 can read “Lowest Prices on Zoom Smart Phones.” The anchor text extracted from the second web page can be identified by the ad creative generator 206 for use in generating an ad creative for the web page 204.

In some implementations, the ad creative generator 206 can disregard text of the web page 204 that is identified as a product number or product code. For example, the ad creative generator 206 can identify a model number 222 included in the web page 204 as not being useful in generating an ad creative. In some implementations, the ad creative generator 206 can identify the model number 222 as a product number since it contains a semi-random string of alphanumeric characters that do not form a word in the English language.

The ad creative generator 206 can use information extracted from the web page 204 to generate the ad creative 208. In some implementations, the ad creative generator 206 can compare the information extracted from the web page 204 to a received query to identify portions of the web page 204 to use in generating an ad creative. For example, the ad creative generator 206 can generate the ad creative 208 in response to a received query of “Zoom Smart Phone.” The ad creative generator 206 can compare the received query to the header 212, the title 210 or both in order to generate a title for the ad creative 208. In some implementations, the ad creative generator 206 can compare the received query to other text associated with the web page 204 (e.g., the body text 214) or anchor text associated with one or more links to the web page 204. In some implementations, the ad creative generator 206 compares the received query to various identified text segments extracted from the web page 204 to identify one or more relevant text segments. For example, the ad creative generator 206 can identify the header 212 as having more words in common with the received query than other text associated with the web page 204. Based on this identifying, the ad creative generator 206 can use some or all of the text of the header 212 as a title for the web page 204.

In some implementations, the ad creative generator 206 can divide identified character strings into sub-strings. For example, the ad creative generator 206 can divide the title 210 or a string of anchor text into sub-strings. In some implementations, the ad creative generator 206 can divide character strings into sub-strings by identifying n-grams within the character strings. An n-gram is a sequence of n number of words identified within a character string. An n-gram where n=2 can be referred to as a bigram and an n-gram where n=3 can be referred to as a trigram. The ad creative generator 206 can identify n-grams within character strings in order to determine words within character strings that should not be split apart. For example, the ad creative generator 206 can determine that when the words “surf” and “board” appear together in sequence, the words are used as a single term (i.e., “surf board”) and should not be split up. In some implementations, strings of words can be identified as n-grams based on how often the words appear together over a large set of content. For example, the ad creative generator 206 can determine how often two words appear together within all web pages included in a web site. As another example, the ad creative generator 206 can identify how often two words appear together over a large set of web pages (e.g., an entire web domain, or the Internet).

Still referring to FIG. 2, in the example shown, the ad creative generator 206 can identify n-grams of “Cool Phone Co,” and “Zoom Smart” within the header 212. In this example, “Cool Phone Co” is the name of a cell phone manufacturer, and therefore the three words appear together often and can be identified by the ad creative generator 206 as a trigram. The character string “Zoom Smart” is the name of a particular cell phone model in this example, and can therefore be identified by the ad creative generator 206 as a bigram. The ad creative generator 206 can compare the received query to the header 212 in order to identify one or more n-grams within the header 212 for use in generating an ad creative title 224 for the ad creative 208. For example, for the query of “Zoom Smart Phone,” the ad creative generator 206 can identify the n-gram of “Zoom Smart” as being most relevant to the query and use “Zoom Smart” as or in the ad creative title 224.

In some implementations, although an n-gram matches one or more words in a received query, the system may elect to not use the n-gram in the creative. For example, the n-gram “Cool Phone Co” matches the word “Phone” within the example query described above. The ad creative generator 206 can elect not to select the n-gram “Cool Phone Co” for use in the ad creative title 224 since the query does not match the entire n-gram of “Cool Phone Co.” In some implementations, the ad creative generator 206 can identify “Cool Phone Co” as a specific company name and “Phone” as a more general word that can refer to many other terms aside from the company name “Cool Phone Co” and therefore elect to not use the n-gram “Cool Phone Co” in the ad creative title 224.

In some implementations, the ad creative generator 206 can identify all possible combinations of n-grams and other words within identified character strings as potential ad creative titles. In some implementations, the ad creative generator 206 can use additional information to generate some or all of the potential ad creative titles. The ad creative generator 206 can then apply rules to select the ad creative title 224 from among the potential ad creative titles. For example, the ad creative generator 206 can implement a rule to only select potential ad creative titles that begin with a word found within the received query. As another example, the ad creative generator 206 can eliminate potential ad creative titles that begin with a word that is identified as a generic word. For example, a character string identified as a title for a web page can be “RunMax Size 13 Running Shoe.” The word “size” within this title can be identified as a generic word. The ad creative generator 206 can then eliminate potential ad creative titles generated from the title “RunMax Size 13 Running Shoe” that begin with the word “size.”

In some implementations, the ad creative generator 206 can apply ranking scores to potential ad creative titles in order to rank the potential ad creative titles and select a best ad creative title from among the potential ad creative titles. Attributes that can be used to rank the potential ad creative titles can include length, number of words, number of n-grams, intersection with a received query (e.g., number of words matched or percentage of words matched), number of prepositions or location of prepositions, number of short words (e.g., articles), number of generic words, or model numbers included in the potential ad creative titles.

For example, the ad creative generator 206 can compare the received query of “Zoom Smart Phone” to the ad creative title 224 of “Zoom Smart” to identify an intersection between the received query and the ad creative title 224. In this example, all of the words included in the ad creative title 224 intersect with words in the query. As a result of the comparison, the ad creative title 224 can be given a relatively high ranking score compared to other potential ad creative titles. Continuing with this example, a potential ad creative title of “Cool Phone Co—Black” Can be given a lower ranking score than the ad creative title 224 since the potential ad creative title “Cool Phone Co—Black” intersects with only one word of the received query.

As another example, long potential ad creative titles that do not exceed a maximum threshold can be given higher ranking scores than potential ad creative titles that are shorter. As another example, an potential ad creative title that includes two n-grams can be given a higher ranking score than a potential ad creative title that includes one or does not include any n-grams. As yet another example, a potential ad creative title that ends in a proposition can be given a lower ranking score than a potential ad creative title that does not end in a preposition. As yet another example, potential ad creative titles that include model numbers or part numbers can be penalized (i.e., given lower ranking scores than other potential ad creative titles). In some implementations, after ranking scores have been determined for potential ad creative titles, one or more ad creative titles having the highest ranking scores can be selected for use in generating ad creatives.

In some implementations, additional text can be included in ad creatives generated by the ad creative generator 206. In some implementations, the additional text included in an ad creative can be generic text that is used for multiple automatically generated ad creatives associated with a group of commercial landing pages. The generic text can be associated with a web site without being specifically associated with a web page for which an ad creative is being generated. For example, generic text associated with a web site that includes the web page 204 can be used for some or all of the ad creatives generated in association with web pages included in the web site. In the example shown, the text “Get the best electronics at the lowest prices” can be generic text that is included in all ad creatives that are automatically generated in association with web pages included in the “cellphonestore.com” web site.

In some implementations, additional text included in an automatically generated ad creative can be generated by the ad creative generator 206 using identified character strings associated with the web page 204. The identified character strings can include the title 210, the header 212, the body text 214, the price 216, anchor text associated with the web page 204, or any other text or content associated with the web page 204. In some implementations, additional text for ad creatives can be generated as described above for the ad creative title 224. For example, a query of “Zoom Smart touch screen” can be compared to the body text 214 to identify an intersection between the search terms “touch screen” and the character string “touch screen functionality.” The ad creative generator 206 can identify the text “touch screen functionality” for inclusion in an automatically generated ad creative as additional text for the ad creative.

In some implementations, the ad creative 208 includes a link 226. The link 226 can be a link to the web page 204. In some implementations, the URL 220 can be used as the link 226. In some implementations, a URL for the web site that includes the web page 204 can be used as the link 226. In some implementations, the URL for the web site that includes that web page 204 can be displayed within the ad creative 208 as the link 226, while the URL 220 is used as the actual link. For example, the URL “cellphonestore.com” is displayed in the ad creative 208 while the URL 220 “http:///www.cellphonestore.com/XK37205” is the URL for the web page that is loaded if a user selects the link 226.

In some implementations, the ad creative generator 206 can generate ad creatives that include one or more images associated with the web page 204. For example, the ad creative generator 206 can insert the image 218 into the ad creative 208. In some implementations, a request for an ad can indicate if the requested ad should include an image. The ad creative generator 206 can include an image in the automatically generated ad creative based on whether or not the ad request indicates if the ad creative should include an image.

In some implementations, the ad creative generator 206 can generate multiple ad creatives for a web page (e.g., for the web page 204). The ad creative generator 206 can apply ranking scores to the multiple ad creatives in order to select one or more highest ranked ad creatives to provide in response to a received ad request. In some implementations, the ranking scores can be applied to the ad creatives as described above for the potential ad creative titles.

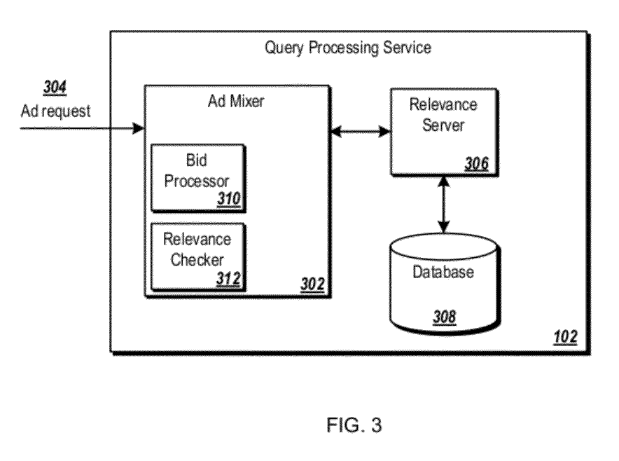

Referring now to FIG. 3, an example architecture for the query processing service system 102 is shown. The query processing service 102 can include an ad mixer 302 that receives an ad request 304. In some implementations, the ad request 304 can take the form of a user entered search query, for example, the search string 110 of FIG. 1. In some implementations, the ad request 304 can include a user entered search query, and additional information, such as profile information about a user who entered the query, or geo-location information indicating where the ad request 304 originated. The additional information can be provided on an opt in basis. That is, users of the query processing system can elect to provide the additional information or not.

In some implementations, the ad request 304 can be a request initiated by code included in a web page being loaded by a web browser. For example, a content provider can provide a web page to a client device for display to a user. The web page can include advertising slots for displaying one or more ads provided by an ad serving system. In some implementations, the query processing service 102 can serve as the ad serving system. The ad slots can be designated portions of the web page which execute code that causes the ad request 304 to be sent to the query processing service 102. In some implementations, The loading of the web page by a browser or other application can cause the ad slot code to execute and initiate the ad request 304. The ad request 304 can include keywords associated with the web page that can be used to identify commercial landing pages that are relevant to the web page.

In some implementations, the ad mixer 302 can send the received ad request 304 to a relevance server 306. The relevance server 306 can access a database 308 in order to provide one or more ad creatives in response to the ad request 304. In a first example scenario, the database 308 can include links between queries and commercial landing pages. The relevance server 306 can identify the query included in the ad request 304 within the database 308 to identify commercial landing pages that are associated with the query. In some implementations, the database 308 can be used to generate relevance scores to indicate commercial landing pages that are most relevant to the query. In some implementations, the relevance server 306 can select a set number (e.g., 3) of commercial landing pages that are identified as being most relevant to the query. In some implementations, an advertiser can provide one or more keywords in association with a commercial landing page. The keywords can be stored in the database 308 in association with links to the commercial landing pages. The keywords can be used to match keywords included in the ad request 304 to a commercial landing page. In some implementations, advertisers do not provide keywords in association with some or all of the commercial landing pages included in the database 308.

In some implementations, the relevance server 306 or an associated system can access the identified commercial landing pages and extract information from the identified commercial landing pages in order to generate ad creatives. For example, the relevance server can include or communicate with an ad creative generator (e.g., the ad creative generator 206 of FIG. 2) for generating ad creatives from information extracted from commercial landing pages. Text, images, and other information extracted from the commercial landing pages can be used to generate the ad creatives as described above with reference to FIG. 2. The ad creatives can additionally include links that link back to the commercial landing pages.

In some implementations, generating an ad creative using information extracted from a commercial landing page can include identifying a title for the commercial landing page or other important text of the commercial landing page. For example, a title for a commercial landing page can be identified by HTML tags within HTML code for the commercial landing page. The HTML tags can include title tags, header tags, bold tags, italics tags, underlining tags, font tags, color tags, or size tags. In some implementations, other methods aside from identifying tags can be used to identify emphasized features such as bolding, italics, underlining, font, color, or size. In some implementations, text having a different font, size, color, or other attribute from other text included in a commercial landing page can be identified as a title for the commercial landing page. In some implementations, position of text within a commercial landing page can be used to identify a title for the commercial landing page. For example, text that is located near the top and/or center of the commercial landing page can be identified as a title for the commercial landing page. In some implementations, multiple text segments can be identified as titles for a commercial landing page. For example, several different character strings of bold text can be identified as titles for the commercial landing page.

In a second example scenario, the database 308 can include links between queries or keywords and ad creative data structures that include metadata associated with commercial landing pages. An ad creative data structure can include, for example, information extracted from a commercial landing page that can be used to generate an ad creative for the commercial landing page. In some implementations, the information can include one or more titles extracted from a header of a commercial landing page (e.g., a page title, a header, or prominent text), one or more images, and a destination URL for the commercial landing page or a web page associated with the commercial landing page. For example, if a commercial landing page includes bolded text that reads “Brand X Basketballs,” the text can be identified as a title for the commercial landing page and used as a title for an ad creative generated in association with the commercial landing page.

In some implementations, the ad creative data structure can include text extracted from anchors that link to the commercial landing page. As described above, an anchor is the text associated with a hyperlink that links to the commercial landing page. For example, a link on a first web page that links to a second web page where a user can purchase flowers can include anchor text reading “Flowers delivered to your door.” The anchor text extracted from the first web page can be stored in an ad creative data structure for the second web page and subsequently used as a title or other text for an ad creative for the second web page.

In some implementations, the ad creative data structure can include segmentation data that identifies n-grams in a title or other text associated with a commercial landing page. For example, a title for a commercial landing page can be “Surf Boards and Wet Suits by Brand XYZ.” Segmentation data stored in an ad creative data structure for the commercial landing page can indicate 2 word n-grams (i.e., bi-grams) identified in the title as “Surf Boards,” “Wet Suits,” and “Brand XYZ.” In some instances, identifying n-grams can include identifying two or more words that should not be split up. In some implementations, the determination can be based on how often the two or more words appear together or whether the identified words provide context. For example, the words “size thirteen” can be identified as an n-gram since the two words together provide context which would be lost if they are separated.

In some implementations, the database 308 can be populated with links between queries and the ad creative data structures when queries are identified that resolve to commercial landing pages. Each time a query is identified as resolving to a commercial landing page, the query can be associated with an ad creative data structure for the commercial landing page in the database 308. If an ad creative data structure for the commercial landing page does not already exist within the database 308, an ad creative data structure can be generated for the commercial landing page and stored in the database 308. In some implementations, advertisers can provide keywords for one or more commercial landing pages. The keywords can be linked to the ad creative data structures associated with the commercial landing pages within the database 308 and used to match queries or keywords included in the ad request 304 to ad creative data structures. In some implementations, keywords are not provided for the commercial landing pages. In some implementations, queries that resolve to commercial landing pages are identified as described above and the queries are linked to ad creative data structures associated with the commercial landing pages within the database 308.

The information included in the ad creative data structures can be used to generate ad creatives for the associated commercial landing pages. In some implementations, the relevance server 306 (or an ad creative generator associated with the relevance server) can generate multiple ad creatives using a single identified ad creative data structure. In some implementations, the relevance server 306 can apply ranking scores to the generated ad creatives in order to identify a highest ranked ad creative for the associated commercial landing page. In some implementations, ranking scores can be at least partially based on relevance of an ad creative to the ad request 304. In some implementations, other attributes of ad creatives can be used to apply ranking scores. Attributes that can be used to rank the ad creatives can include length of title or other text, number of words, number of n-grams, intersection of title or other text with a received query (e.g., number of words matched or percentage of words matched), size of the ad creative, shape of the ad creative, number of images in the ad creative, relevance of images in the ad creative, number of prepositions or location of prepositions, number of short words (e.g., articles), number of generic words, or model numbers included in the title or other text. In some implementations, upon applying ranking scores, the relevance server 306 can select one or more highest ranked ad creatives to provide in response to the ad request 304.

In a third example scenario, the database 308 can include links between queries and ad creatives for commercial landing pages. In some implementations, the database 308 can be populated with query/ad creative pairs as queries are identified as resolving to commercial landing pages. In some implementations, the database 308 can be populated with keywords/ad creative pairs where the keywords are provided by advertisers. In some implementations, the ad creatives can be generated from information extracted from commercial landing pages as described above and stored in the database 308.

The relevance server 306 can provide generated or identified ad creatives identified as being most relevant to the ad request 304 to the ad mixer 302. In some implementations, the ad creatives provided by the relevance server 306 can include ad creatives for multiple advertisers associated with commercial landing pages that are relevant to the ad request 304. In some implementations, multiple ad creatives can be provided by the relevance server 306 for a single commercial landing page identified as being relevant to the ad request 304.

The ad mixer 302 can add the received ad creatives to a database of ad creatives that includes other ad creatives, including ad creatives provided by advertisers. In some implementations, the ad mixer 302 can use conventional ad selection methods to identify ads to supply in response to the ad request 304. For example, the ad mixer 302 can include a bid processor 310. The bid processor 310 can process bids for advertisers associated with the automatically generated ad creatives as well as ad creatives that are provided directly by advertisers in order to select one or more ads having the highest bids to provide in response to the ad request 304.

In some implementations, if multiple ad creatives are associated with bids that are tied for the highest bid, or if a bidding process is not used to select ad creatives, the ad mixer 302 can use a relevance checker 312 to identify ads that are the most relevant to the ad request 304. In addition to identifying ad relevance based on relevance to a query included in the ad request 304, other information associated with the ad request can be used to apply relevance scores to ad creatives. Additional information can be provided by the user in an opt in system. Additional information that can be used to apply relevance scores to ad creatives can include geo-location information (e.g., location where ad request 304 originated, or location of a business associated with an ad), demographic information, or time stamp information. For example, if the query is for “restaurant” and the time of day in the area where the ad request 304 originated is 1:00 am, ads for all night diners can be identified as being most relevant to the query, whereas if the time of day is 10:00 am, ads for restaurants specializing in brunch can be identified as being most relevant. As another example, if the query is “men's shirts,” demographic information for a user associated with the ad request 304 can be used to identify clothing ads that would most to users located in the same general geographic location as the user.

Ads identified by the bid processor 310 and/or the relevance checker 312 (e.g., as having winning bids or being the most relevant) can be supplied by the ad mixer 302 to an end user system (e.g., the client device 104 of FIG. 1) for presentation to an end user. In some implementations, the ads provided by the ad mixer 302 can include both automatically generated ads and ads provided directly by advertisers.

In some implementations, the components of the query processing service 102 can generate ad creatives from source material other than a web page. For example, electronic documents, PDFs, product brochures, or other materials which include content associated with a purchasable product or service can be used to automatically generate ad creatives.

In some implementations, the components of the query processing service 102 can perform a process which includes a step of identifying a content item from a content source that is to be a basis for an advertisement creative. For example, a brochure for a lawn mower can be identified within a database of product brochures. As another example, a text file containing information about a brand of golf clubs can be identified within a file directory structure. The process can further include extracting content from the content item to create an advertisement for serving in response to a request. In some implementations the extracting step can include extracting one or more of a title, header or emphasized content from the content item. Titles, headers, and emphasized content (e.g., bolded, italicized, or capitalized text) can be identified as described above.

The process can further include creating an advertisement creative title for the advertisement creative based on the request and the extracted content. For example, the extracted content can be compared to the request to identify intersections between the request and the extracted content. Portions of the extracted content that intersect with the request can be used to create the advertisement creative title. In some implementations, creating an advertisement creative title for the advertisement creative based on the request and the extracted content can include identifying known compounds (e.g., n-grams) within the extracted content.

The process can further include combining a body with the advertising creative title and combining with the body a uniform resource locator (URL) for a landing page that is to be associated with the advertisement creative. In some implementations, the body can be generic or semi-generic text that is associated with an advertiser or group of content items. In some implementations, the body can be generated using the extracted content or other content extracted from the content item. In some implementations, the URL can be a URL for a web site associated with the advertiser. In some implementations, the URL can be a URL for a particular web page that is associated with a product or service described by or otherwise associated with the content item.

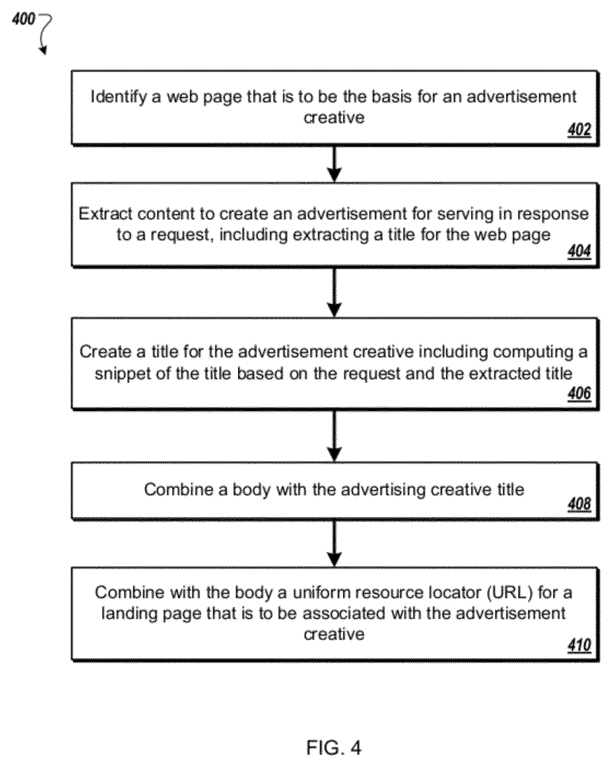

Referring now to FIG. 4, a method 400 is shown for generating an advertisement creative using information extracted from a web page. The method 400 can be performed by a system, such as the query processing service 102 shown in FIG. 3, the ad creative generator 206 of FIG. 2, or the system 100 shown in FIG. 1. At stage 402, a web page that is to be the basis for an advertisement creative is identified. For example, a query entered by an end user can be received by a query processing service. The query processing service can access a database that contains links between queries and web pages (e.g., commercial landing pages). The query processing service can compare the received query to queries contained in the database to identify a web page associated with the query. In some implementations, rather than access a database of query/web page pairs, the query processing service can perform a search of commercial landing pages to identify a commercial landing page that is a match for the received query.

In some implementations, rather than identifying a web page in response to a received query or a received ad request, a web page can be identified by an advertiser. For example, an advertiser can indicate one or more web pages to an ad creative generator. The ad creative generator can then access the indicated web pages. In some implementations, the one or more web sites associated with an advertiser can be searched to identify pages included in the web sites that are not currently targeted for advertising purposes. For example, a sporting goods manufacturer can have a web site that includes web pages that provide information on products sold by the sporting goods manufacturer. In some instances, the web pages can allow users to purchase the sporting goods. In some implementations, the ad serving system can identify product pages for which ads are not currently being served to end users. In some implementations, the ad serving system can determine if identified web pages are in fact associated with a purchasable product or service.

At stage 404, content is extracted to create an advertisement for serving in response to a request, including extracting a title for the web page. Content that can be extracted from a web page can include text, images, and/or network addresses (e.g., URLs). In some implementations, extracting a title for the web page can include identifying anchor text for links located on other web pages that link to the identified web page. In some implementations, extracting content can include identifying URLs or network addresses for other web pages associated with the identified web page. In some implementations, the identified web page can include multiple titles and extracting a title for the web page can include extracting one or more of the multiple titles for the web page. In some implementations, a title for the web page can be identified by tags (e.g., HTML title or header tags), or emphasis (e.g. font size, italics, bolding, underlining, color, font, or position) on the page. For example, a character string that contains six words and is positioned between two long paragraphs can be identified as a title for the web page. As another example, bolded text located near the top of the web page can be identified as a title. As yet another example, text that appears in a different font than the majority of the other text of the web page can be identified as a title. In some implementations, the content extracted from the web page can be stored in a database. For example, the extracted content can be stored as metadata within an ad creative data structure.

At stage 406, a title for the advertisement creative is created. Creating the creative can include computing a snippet of the title based on the request and the extracted title. For example, a query or keywords included in the request can be compared to the extracted title to identify portions of the extracted title that are most relevant to the received request. The portions of the title that are identified as most relevant can be used to create a title for the ad creative. In some implementations, n-grams included in the extracted title can be identified. The title for the ad creative can be created such that words that make up n-grams identified in the extracted title are not separated from each other. In some implementations, n-grams that have the highest rate of intersection with a received query or keywords can be combined to create the ad creative title. In some implementations, creating an ad creative title can include creating multiple potential ad creative titles and applying ranking scores to the ad creative titles based on various attributes of the ad creative titles. A potential ad creative title having the highest ranking score can be selected as the ad creative title

At stage 408, a body is combined with the advertising creative title. For example, referring to FIG. 2, the generated ad creative title 224 can be combined with a body of “Get the best electronics at the lowest prices.” In some implementations, the body that is combined with the ad creative title can be generic text that is used for multiple ad creatives. For example, an advertiser can specify two lines of generic text to be used as a body for all ad creatives generated for web pages included in a particular web site. In some implementations, the body can be dynamically generated using extracted content associated with the web page, information included in the received request, or a combination of both. In some implementations, the body can be generated in a similar manner as that described above for generating the ad creative title. For example, an intersection between a query included in the received request and text extracted from the web page can be identified. The section of web page text that intersects with the query can be used to create the body for the ad creative.

At stage 410, the body is combined with a uniform resource locator (URL) for a landing page that is to be associated with the advertisement creative. In some implementations, the URL for the landing page can be the URL of the web page identified at stage 402. In some implementations, the URL for the landing page can be a URL for a web page associated with the identified web page. For example, a URL for a front page of a web site that includes that identified web page can be used as the URL for the landing page. In some implementations, a first URL can be displayed in the ad creative while a second URL is used to access a landing page upon selection of the ad creative. For example, an ad creative can display a URL of “onlinesportsstore.net” and include a link through URL of “http://www.onlinesportsstore.net/equipment/badminton/shuttlecocks.”

In some implementations, the method 400 can include fewer or additional steps. For example, the method 400 can include a step of identifying n-grams within the extracted title or a step of stripping non-essential material from the extracted title to create a stripped title. In some implementations, steps of the method 400 can be performed in a different order. For example, the step of combining the body with the URL can be performed before the step of combining the body with the ad creative title.

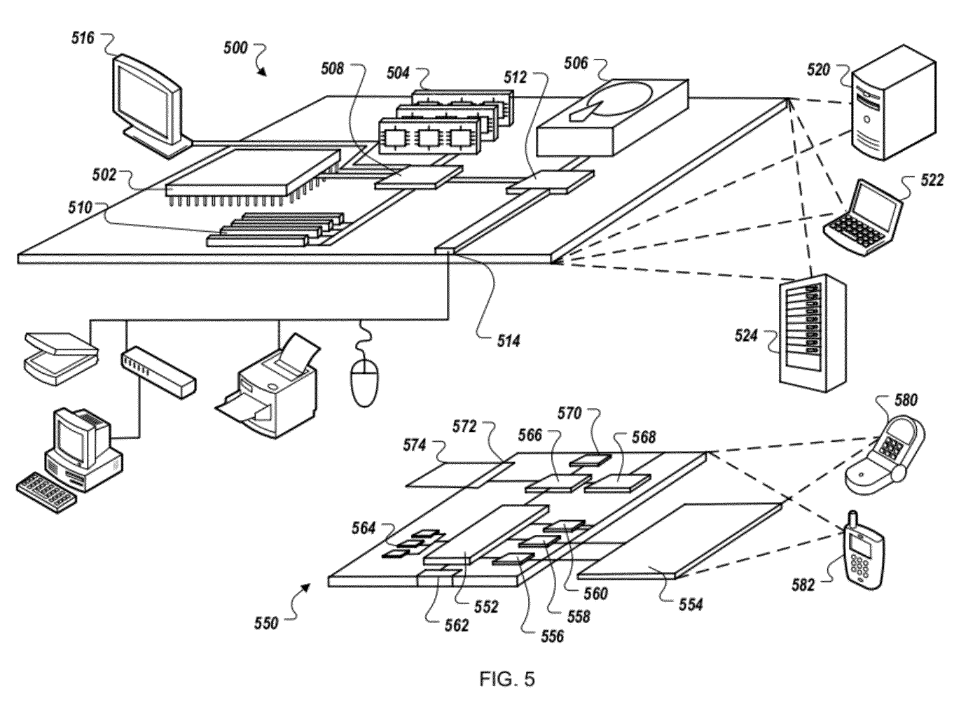

FIG. 5 is a block diagram of computing devices 500, 550 that may be used to implement the systems and methods described in this document, as either a client or as a server or plurality of servers. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a computer-readable medium. In one implementation, the memory 504 is a volatile memory unit or units. In another implementation, the memory 504 is a non-volatile memory unit or units.

The storage device 506 is capable of providing mass storage for the computing device 500. In one implementation, the storage device 506 is a computer-readable medium. In various different implementations, the storage device 506 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 504, the storage device 506, or a memory on processor 502.

The high speed controller 508 manages bandwidth-intensive operations for the computing device 500, while the low speed controller 512 manages lower bandwidth-intensive operations. Such allocation of duties is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can process instructions for execution within the computing device 550, including instructions stored in the memory 564. The processor may also include separate analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD display or an OLED display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication (e.g., via a docking procedure) or for wireless communication (e.g., via Bluetooth or other such technologies).

The memory 564 stores information within the computing device 550. In one implementation, the memory 564 is a computer-readable medium. In one implementation, the memory 564 is a volatile memory unit or units. In another implementation, the memory 564 is a non-volatile memory unit or units. Expansion memory 574 may also be provided and connected to device 550 through expansion interface 572, which may include, for example, a SIMM card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS receiver module 570 may provide additional wireless data to device 550, which may be used as appropriate by applications running on device 550.

Device 550 may also communication audibly using audio codec 560, which may receive spoken information from a user and convert it to usable digital information. Audio codex 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smartphone 582, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
identifying a web page that is to be a basis for an advertisement creative;
extracting content to create an advertisement for serving in response to a request, extracting including extracting a title for the web page;
creating a title for the advertisement creative including computing a snippet of the title based on the request and the extracted title;
combining a body with the advertising creative title; and
combining with the body a uniform resource locator (URL) for a landing page that is to be associated with the advertisement creative.

2. The method of claim 1 wherein the request is a query.

3. The method of claim 1 wherein the request is a request for one or more advertisements to be published along with other content on a serving page.

4. The method of claim 1 wherein the body includes two lines and is based on content on the web page.

5. The method of claim 1 wherein the body includes two lines and is generic and not specifically related to the web page.

6. The method of claim 1 wherein extracting the title includes identifying text that is in a larger font than other text in the web page.

7. The method of claim 1 wherein extracting the title includes identifying anchors associated with the web page.

8. The method of claim 1 wherein extracting the title includes identifying bi-grams and/or other n-grams in the title.

9. The method of claim 1 wherein extracting the title includes:
identifying the title of the web page;
identifying and stripping non-essential material from within the title to create a stripped title;
segmenting the stripped title into known compounds to create an extracted title; and wherein creating the title for the advertisement creative includes
computing the intersection between the request and the extracted title.

10. The method of claim 9 wherein creating the title for the advertisement creative further includes:
generating all possible title snippets using a number of algorithmic rules;
scoring the title snippets; and
selecting a best snippet from the scored snippets for use as the advertisement creative title.

11. The method of claim 10 wherein combining a body further includes combining a best title with generic text.

12. The method of claim 10 wherein combining a URL further includes combining a URL for an advertiser associated with the web page and a link to a specific page to the body.

13. A method comprising:
identifying a content item from a content source that is to be a basis for an advertisement creative;
extracting content from the content item to create an advertisement for serving in response to a request, extracting including extracting one or more of a title, header or emphasized content from the content item;
creating an advertisement creative title for the advertisement creative based on the request and the extracted content;
combining a body with the advertising creative title; and
combining with the body a uniform resource locator (URL) for a landing page that is to be associated with the advertisement creative.

14. The method of claim 13 wherein the request is a query.

15. The method of claim 13 wherein the request is a request for one or more advertisements to be published along with other content on a serving page.

16. The method of claim 13 wherein the body includes two lines and is based on content included in the content item.

17. The method of claim 13 wherein the body includes two lines and is generic and not specifically related to the content item.

18. The method of claim 13 wherein extracting the title includes identifying text that is in a larger font than other text in the content item.

19. The method of claim 13 wherein extracting the title includes identifying anchors associated with the content item.

20. The method of claim 13 wherein extracting the title includes identifying bi-grams and/or other n-grams in the title.

21. The method of claim 13 wherein extracting the title includes:
identifying the title of the content item;
identifying and stripping non-essential material from within the title to create a stripped title;
segmenting the stripped title into known compounds to create an extracted title; and wherein creating the title for the advertisement creative includes
computing the intersection between the request and the extracted title.

22. The method of claim 21 wherein creating the title for the advertisement creative further includes:
generating all possible title snippets using a number of algorithmic rules;
scoring the title snippets; and
selecting a best snippet from the scored snippets for use as the advertisement creative title.

23. The method of claim 22 wherein combining a body further includes combining a best title with generic text.

24. The method of claim 22 wherein combining a URL further includes combining a URL for an advertiser associated with the content item and a link to a specific page to the body.
